(19) United States
(12) Patent Application Publication
(10) Pub. No.: US 2007/0246918 A1
(43) Pub. Date: Oct. 25, 2007

(54) Instrument panel with integral hidden door cover and method of manufacture thereof

(76) Inventors: Phillip B. Speelman, Dayton, OH (US); Mark B. Wolfe, Franklin, OH (US)

Correspondence Address: DELPHI TECHNOLOGIES, INC., M/C 480-410-202, PO BOX 5052, TROY, MI, 48007, US

(21) Appl. No.: 11/408,537

(22) Filed: Apr. 21, 2006

(51) Int. Cl. B60R 21/205; B60R 21/215

(52) U.S. Cl. 280/728.3; 280/732

(57) ABSTRACT

An instrument panel having a hidden airbag module door opening, the instrument panel comprising: an outer layer having a show surface and an inner surface; an inner layer having a deployment opening disposed therein; an intermediary layer disposed between the outer layer and the inner layer; and a door member secured about the deployment opening via a mounting bracket, wherein a flange portion comprising a hinge is secured between a peripheral edge portion of the deployment opening and the mounting bracket and a separable flange portion of the door member is secured between another peripheral edge portion of the deployment opening and the mounting bracket, wherein the separable flange portion removably secures a portion of the door member to the inner layer, wherein the door member and the bracket are secured to the inner layer prior to the application of the intermediary layer and the intermediary layer covers the door member and the bracket and wherein the periphery of the door member is not visually perceivable from the outer layer.

### TECHNICAL FIELD

The present invention relates generally to an instrument panel used in a vehicle having an inflatable cushion or airbag module, and more particularly to an instrument panel cover having an integral hidden door and the method of manufacture thereof.

### BACKGROUND

Vehicles are now equipped with some type of inflatable cushions or airbag modules and other vehicle components have been modified to accommodate the use of such systems. For example, most passenger side airbag modules are disposed within and behind an instrument panel which extends across at least a portion of the width of a vehicle compartment. During assembly and/or manufacture, an instrument panel in a vehicle having a passenger side airbag module requires a discrete door which covers an opening formed in the instrument panel for the inflatable cushion to deploy through upon actuation of the airbag module. This separate door is designed to open in response to the force of the expanding inflatable cushion. In other words as the pressure in the inflatable cushion increases, the volume of the cushion increases and applies a force to a portion of the door wherein the door selectively separates from the remaining portion of the instrument panel to permit the inflatable cushion to deploy therethrough.

Typically, the manufacture of the instrument panel involves forming an opening in the instrument panel adjacent to the location of the airbag module. The opening is then covered by a separate door which is secured to the instrument panel and faces the occupants of the vehicle. Thus, the instrument panel itself is manufactured in view of the shape and size of the door and the door is separately manufactured and installed in the instrument panel using known techniques. However, the outer periphery of such a door is clearly visible to the vehicle occupant and may create an unpleasing appearance to the instrument panel.

Due to ongoing desires for improving the aesthetics of the passenger compartment, it is desirable to provide aesthetically pleasing, functional alternatives to the conventional instrument panels having a separate door covering the airbag module.

### SUMMARY OF THE INVENTION

According to the present invention, an instrument panel having a hidden deployment region or deployable door secured to an instrument panel is provided. More specifically, an instrument panel and method of making an instrument panel for use in a vehicle having a passenger side airbag module is disclosed.

In one exemplary embodiment an instrument panel with a hidden airbag module door opening is provided. The instrument panel comprising: an outer layer having a show surface and an inner surface; an inner layer having a deployment opening disposed therein; an intermediary layer disposed between the outer layer and the inner layer; and a door member secured about the deployment opening via a mounting bracket, wherein a flange portion comprising a hinge is secured between a peripheral edge portion of the deployment opening and the mounting bracket and a separable flange portion of the door member is secured between another peripheral edge portion of the deployment opening and the mounting bracket, wherein the separable flange portion removably secures a portion of the door member to the inner layer, wherein the door member and the bracket are secured to the inner layer prior to the application of the intermediary layer and the intermediary layer covers the door member and the bracket and wherein the periphery of the door member is not visually perceivable from the outer layer.

Also disclosed herein is an instrument panel and airbag module assembly. The assembly comprising: an outer layer having a show surface and an inner surface, the outer layer having at least one score disposed in the inner surface, wherein the at least one score is not visually perceivable from the show surface; an inner layer having a deployment opening disposed therein; an intermediary layer disposed between the outer layer and the inner layer; a door member secured about the deployment opening via a mounting bracket, wherein a flange portion comprising a hinge is secured between an upper peripheral edge portion of the deployment opening and the mounting bracket and a separable flange portion of the door member is secured between another upper peripheral edge portion of the deployment opening and the mounting bracket, wherein the separable flange portion removably secures a portion of the door member to the inner layer, wherein the door member and the bracket are secured to the inner layer prior to the application of the intermediary layer and the intermediary layer covers the door member and the bracket and wherein the periphery of the door member is not visually perceivable from the outer layer; and an airbag module housing secured to a lower peripheral edge portion of the deployment opening via a plurality of studs passing through a portion of the mounting bracket, the flange portion and a mounting member of the air bag module housing.

In another exemplary embodiment a method of forming a hidden, integral passenger airbag door in an instrument panel is disclosed. The method comprising: securing a flange portion and a releasable flange portion of a door member to an upper surface of a peripheral edge of a deployment opening in an inner layer of the instrument panel with a mounting bracket, the mounting bracket having a plurality of rivets securing the releasable flange portion and the flange portion between the peripheral edge of the of the deployment opening and the mounting bracket and a plurality of studs securing the releasable flange portion and the flange portion between the peripheral edge of the of the deployment opening and the mounting bracket, wherein a portion of the plurality of studs is configured to secure a portion of an airbag module to the instrument panel; securing an outer layer and an intermediary layer to the inner layer, the outer layer having a show surface and an inner surface, the outer layer having at least one score disposed in the inner surface, wherein the at least one score is not visually perceivable from the show surface and the intermediary is layer disposed between the outer layer and the inner layer; and wherein the flange portion further comprises a hinge defined by a trough disposed in a surface of the door member and the trough is bounded by reinforcement areas aligned with at least one of the plurality of studs, the reinforcement areas being integrally formed with the door member and depend away from opposite sides of the door member.

### BRIEF DESCRIPTION OF THE DRAWINGS

The present invention will now be described, by way of example only, with reference to the accompanying drawings in which:

FIG. 1 is a partial cross sectional view of a vehicle interior;

FIG. 2 is a partial perspective view of a vehicle interior;

FIG. 3 is a partial view of a portion of an instrument panel constructed in accordance with an exemplary embodiment of the present invention;

FIG. 4 is a cross sectional view along lines 4-4 of FIG. 3;

FIG. 5 is a cross sectional view along lines 5-5 of FIG. 3;

FIG. 6 is a cross sectional view along lines 6-6 of FIG. 3;

FIG. 7 is a plan view of an instrument panel constructed in accordance with an exemplary embodiment of the present invention;

FIG. 8 is a plan view of inner layer contemplated for use with the instrument panel illustrated in FIG. 7;

FIG. 9 is an enlarged view of a portion of FIG. 8 illustrating an airbag deployment area;

FIG. 10 is a view along lines 10-10 of FIG. 7;

FIG. 11 is a view along lines 11-11 of FIG. 7; and

FIGS. 12-14 are cross-sectional views of an alternative exemplary embodiment.

### DETAILED DESCRIPTION OF EXEMPLARY EMBODIMENTS

In accordance with exemplary embodiments of the present invention an instrument panel with a deployable door and invisible tear seam is provided. The deployable door is secured about an opening in an inner layer of the instrument panel prior to the application of a foam or intermediary layer and an outer layer comprising a show surface of the instrument panel. The deployable door is secured via a bracket arrangement wherein portions of the door are releasably secured about a portion of a periphery of the opening in the inner layer and a hinge portion pivotally secures the deployable door to the inner layer as well as the instrument panel. Thereafter, a foam layer is applied between the inner layer comprising the depoyable door mounted thereto and the outer layer. In accordance with an exemplary embodiment, the bracket arrangement will also provide a means for securing an airbag module to the instrument panel wherein an inflatable cushion is positioned to deploy through the opening in the inner layer and cause the deployable door to pivot open while tearing or pushing a portion of the intermediary layer and the outer layer away from the opening allowing for the inflatable cushion to deploy therethrough while a portion of the deployable door is still pivotally secured to the instrument panel.

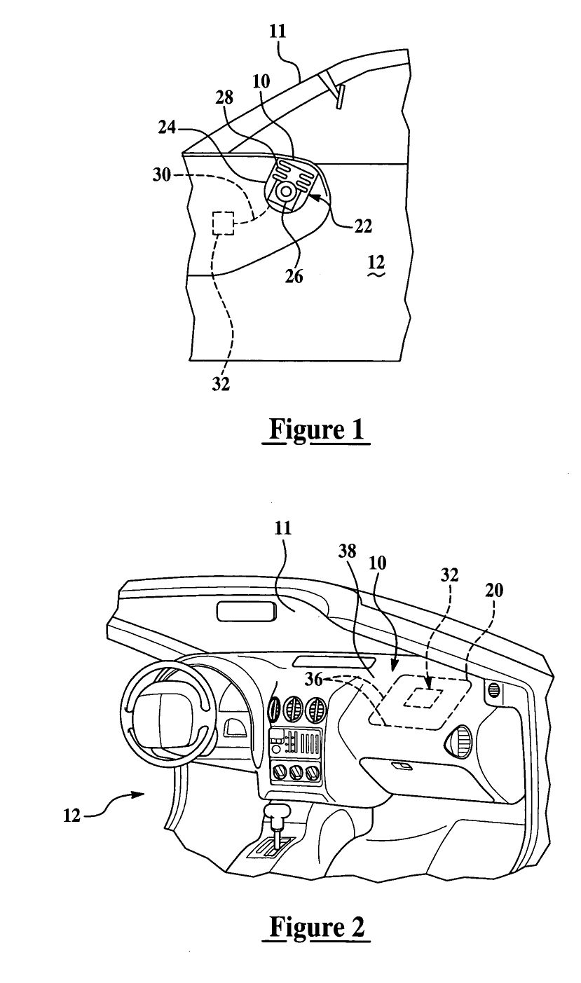

Referring now to FIGS. 1-6, an instrument panel embodying exemplary embodiments of the present invention is illustrated and generally indicated at 10. The instrument panel 10 is assembled into a vehicle passenger compartment 12 partially shown in FIG. 2. The instrument panel is generally disposed beneath a windshield 11 and extends across substantially the entire width of the passenger compartment 12.

In accordance with exemplary embodiments of the present invention and as will be described in greater detail hereinafter, the instrument panel comprises an outer layer 14, an intermediate layer 16 and an inner layer 18. The instrument panel further comprises a deployment region 20 formed therein. The deployment region is intended to be in the general area corresponding to a passenger side airbag module 22. The passenger side airbag module is located and deployed therethrough during actuation of the passenger side airbag module under predetermined deployment conditions. Airbag module 22 further comprises a housing 24, an inflator 26 and an inflatable cushion 28 wherein the inflator inflates the inflatable cushion 28 in response to a signal 30 received from a sensing or control module 32 configured to determine if an activation event is occurring. The control module receives signals from a plurality of sensors disposed throughout the vehicle.

The instrument panel is formed of any number of suitable materials and in an exemplary embodiment; the instrument panel is formed of thermoplastic materials. For example, suitable thermoplastic materials include but are not limited to polyethylene based polyolefin elastomer or polypropylene based thermoplastic elastomer and equivalents thereof.

Preferred materials are those materials that have the desired characteristics of strength, flexibility, and finished appearance and feel for use as an instrument panel 10. As illustrated, the instrument panel is mounted within the vehicle so that an outer surface is visible to a vehicle occupant and an inner surface forms a contact surface for the inflatable cushion.

It is, of course, understood that the passenger side airbag module and the configuration of the instrument panel illustrated in FIG. 1 are provided as examples and various other configurations of the instrument panel and the airbag module are contemplated thus, the present invention is not intended to be limited to the specific configurations illustrated in FIG. 1.

In accordance with an exemplary embodiment of the present invention outer layer 14 comprises an interior show surface of the instrument panel. As described herein shown surface is intended to include the surface of the instrument panel that is exposed to the vehicle interior and its occupants. In an exemplary embodiment, outer layer 14 is formed from a polyurethane material or equivalents thereof. Also, intermediate layer 16 is formed from a polyurethane foam material that is applied between outer layer 14 and inner layer 18. Inner layer 18 is formed from a thermoplastic material in accordance with technologies know to those skilled in the related arts.

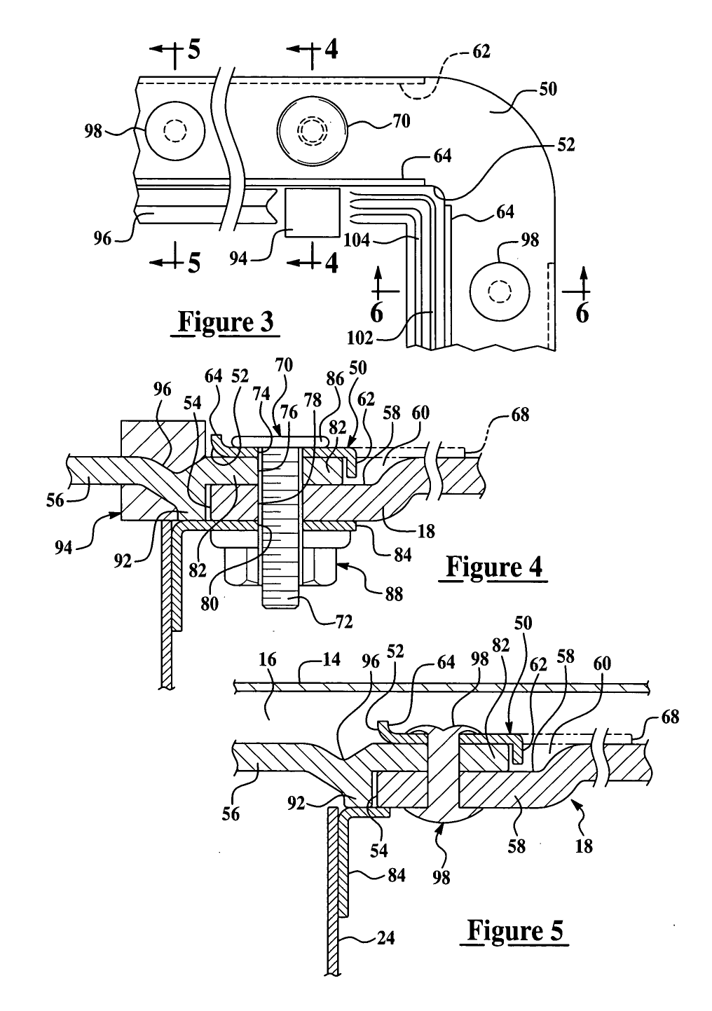

Referring now to FIGS. 3-6 exemplary embodiments of the present invention are illustrated. In a first step outer layer 14 is formed to provide a sheet of material for use as an exterior show surface of an instrument panel of a vehicle. The sheet of outer material is formed from materials including but not limited to polyurethane, poly vinyl chloride (PVC), imitation leather, real leather products and any other equivalent material capable of providing the desired show surface. Thus, a sheet of material having a show surface or an outer aesthetically pleasing appearance is provided. After the sheet of material is formed, a score, sonic score or plurality of cuts or a single cut 36 are/is made in an inner surface of the outer layer. The inner surface being opposite an outer show surface 38 of outer layer 14. In accordance with an exemplary embodiment cuts or cut 36 are/is provided in layer 14 before or alternatively after the application of layers 16 and 18 to the instrument panel.

In one non-limiting exemplary embodiment, show surface 38 of outer layer 14 is configured to have a textured or grainy texture to provide an aesthetically pleasing appearance (e.g., a simulated leather texture).

Cuts 36 are provided by introducing a cutting means such as a cutting knife or an oscillating cutting knife, wherein the knife is either heated or not, or a laser scoring device and equivalents thereof. The cutting means will score the inner surface without extending all the way through layer 14. Thus, the deployment opening of the instrument panel will not be visually perceivable from the show surface of the outer layer. In accordance with an exemplary embodiment, cuts or scores 36 will define a “U” shaped pattern to define three separable or tearing edges and a fourth non-tearing edge that is aligned with a hinge portion of a deployable door, which will be discussed in greater detail below.

The deployment region is formed in the instrument panel so that the inflatable cushion is orientated in front of a passenger seated in the passenger compartment. The instrument panel and more specifically the deployment region, is used to conceal the inflatable cushion in an aesthetically pleasing manner. The deployment region is formed in the instrument panel with the appropriate alignment of the deployment region with the passenger side airbag module so that upon deployment of the inflating cushion the same is forced through the instrument panel at its weakest point. In other words, the inflatable cushion exerts pressure on the inner surface of the instrument panel and causes the deployable door to separate along the scores and cuts formed therein. The deployment region is sized and shaped so that the passenger side air bag cushion successfully deploys therethrough upon actuation. Accordingly, the size of the deployment region is dependent upon the size and shape of the inflatable cushion.

As mentioned above, intermediary layer 16 is a polyurethane foam material or other equivalent materials exhibiting the desired characteristics (e.g., compressibility, resiliency and bondability to an inner surface 44 of layer 14). Accordingly, intermediary layer 16 is applied to outer layer 14 in accordance with known technologies. In one contemplated combination both outer layer 14 and intermediary layer 16 are both polyurethane materials. Of course, other combinations are contemplated in accordance with exemplary embodiments of the present invention. In addition, the foam consistency of intermediary layer 16 allows the same to be torn during deployment of the inflatable cushion.

In one non-limiting exemplary embodiment, both outer layer 14 and inner layer 18 are disposed in a spaced relationship within a mold cavity wherein the intermediary foam layer 16 is applied or injected between layers 14 and 18 in accordance with known technologies.

Referring now to FIGS. 3-6, an exemplary embodiment of the present invention is illustrated. Here a plan view of a right hand outbound forward corner of inner layer 18 is illustrated. This view represents an upper surface of a portion of inner layer 18 and portions of a door member secured thereto in accordance with an exemplary embodiment of the present invention. In accordance with an exemplary embodiment, a halo or metal bracket 50 is disposed about a periphery of the deployment region defined in the instrument panel. In accordance with an exemplary embodiment halo or metal bracket 50 has a rectangular configuration defining an inner opening 52 therein. Opening 52 is configured to be disposed about a periphery of an opening 54 disposed in inner layer 18. In accordance with an exemplary embodiment opening 52 is slightly larger than opening 54. Of course, and as applications may require, openings 52 and 54 may have any other configuration (e.g., circle, ellipse, square, trapezoid, etc.). In addition, bracket 50 may be formed from any suitable material providing the desired characteristics (e.g., steel, other metals, metal alloys and plastics).

In accordance with an exemplary embodiment, halo bracket 50 provides a means for securing a portion of the airbag module housing to the instrument panel as well as providing a means for securing a door member 56 to a peripheral portion 58 of inner layer 18 disposed about or defining opening 54. In addition, bracket 50 also negates the need for an airbag deployment chute to be attached to or integrally molded with inner layer 18. This is achieved by directly securing the bracket to a peripheral portion of the airbag module housing disposed on one side of the inner layer and then securing the bracket on the other side therefore, a peripheral reinforcement of the deployment opening is provided by both bracket 50 and a peripheral edge of the airbag module housing.

As illustrated in FIG. 4, peripheral portion 58 is defined by a recessed area 60 of inner layer 18 and halo bracket 50 is further configured to have a peripheral wall portion 62 disposed about an outer periphery or portions of an outer periphery of the halo bracket and extending towards inner layer 18. Wall portion 62 provides localized reinforcement as well as a locating feature for flange portions of the door member as the bracket is being secured to the door member. Once the door member is secured to the inner layer, recessed area 60 allows the surface of the door member facing the outer layer 14 to be located in substantially the same plane or at the same distance from the outer layer as the surface of inner layer 18, which also faces outer layer 14. This alignment of surfaces of door member 56 and inner layer 18 allows the thickness of the intermediary layer or foam layer to remain, for the most part, at a constant thickness. It is, of course, understood that trough 96, reinforcement areas 94, rib portion 12 and relief portion 104 will cause the thickness to vary in accordance with the desired performance of these features.

In addition, the halo bracket is also configured to have a wall portion 64 depending away from door member 56 towards outer layer 14. It is also understood that peripheral portions of the halo bracket may not comprise wall portions 62 and 64. In addition and in an alternative exemplary embodiment, halo bracket or mounting bracket 50 is configured to have an optional extension 68, which is configured to extend past the relief portion or recessed area of the inner layer 18.

As illustrated in FIG. 4, a threaded weld spud 70 is secured to halo bracket 50 wherein a shaft portion 72 of the weld spud passes through openings 74, 76, 78 and 80 in a mounting flange 82 of the door member, peripheral portion 58 and an “L” shaped mounting bracket 84 of the airbag module respectively, while a head portion 86 makes contact with and is secured to a surface of the halo bracket by for example a welding process. In accordance with an exemplary embodiment, mounting bracket 84 depends away from an outer periphery of the passenger side airbag module and a threaded nut 88 is configured to secure the inner layer and a flange portion 82 of the door member to the housing of the airbag module. Mounting bracket 84 may comprise a portion of the airbag module housing or alternatively may comprise a separate item that is secured (e.g., welded, riveted, or any other suitable means) to the opening of the housing.

Door member 56 is also configured to have a shoulder portion 92, which defines a locator for door member 56 in opening 54 as well as a surface for being received on bracket 84. Thus and as door member 56 is positioned over opening 54, shoulder portion 92 will provide a locating feature for aligning shaft portions 72 with the openings in inner layer 18. Also illustrated in FIG. 4 is a block or reinforcement area 94, which provides a reinforcement of the door member hinge proximate to the weld stud. In accordance with an exemplary embodiment, block area 94 comprises a rectangular member or portion disposed above and below door member 56 in order to increase the thickness of the material comprising the hinge portion located proximate to the securement locations of threaded spuds 70. In accordance with an exemplary embodiment, reinforcement area 94 is approximately 3 mm higher than the door member in order to provide a strengthened area proximate to weld spud 70. Of course, the dimensions of reinforcing block 94 may be greater or less than 3 mm or those dimensions shown in the attached Figures. Although, only a single mounting location using weld spud 70 is illustrated in FIG. 4 it is contemplated that more than one spud and block area may be disposed along the hinge of the door member. Also shown in FIG. 4 is a hinge trough or recess 96, which is disposed along a length of the flange portion of the door member in order to provide a means for door member 56 to pivot outwardly from the instrument panel during an airbag activation event. Hinge trough 96 provides a relief area in order to assist in the pivotal movement of door member 56 towards outer layer 14 during an airbag activation event.

Referring now to FIG. 5, another securement location of the door member to the inner layer or retainer layer 18 of the instrument panel is illustrated. Here peripheral portion 58 is rigidly secured to a flange portion of the door member via securement method such as a machine rivet 98, which passes through complimentary openings in the mounting bracket, the door member and the inner layer. As illustrated, the bracket of the housing of the airbag module is configured to have a shorter length, as this portion is not secured to the halo or mounting bracket. Also shown in FIG. 5 is the hinge trough 96, which will provide a means for door member 56 to pivot about hinge trough 96. Although not specifically, shown in FIG. 5 it is understood that a plurality of rivets will be used to mount the flange portion of the door member to the inner layer.

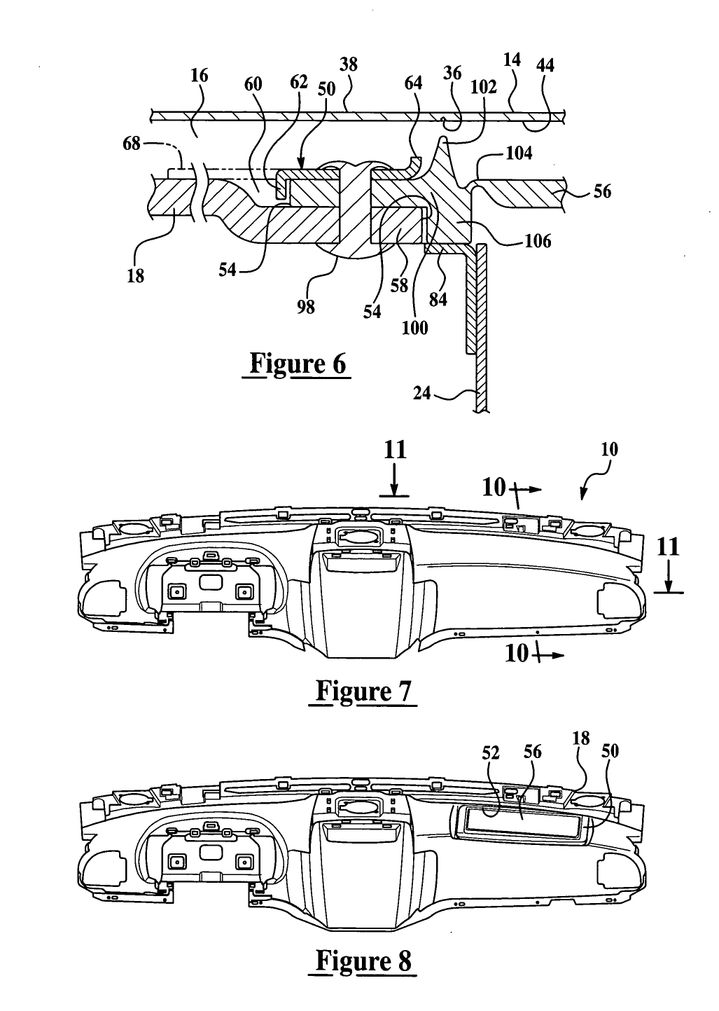

In accordance with an exemplary embodiment, FIGS. 5 and 6 illustrate the securement of the door member to the inner layer or substrate member 18. This securement occurs prior to the injection molding step wherein intermediary layer 16 is disposed between outer layer 14 and inner layer or substrate member 18. On the other hand, FIG. 4 illustrates the securement of an airbag module to the instrument panel, which occurs after the instrument panel has been manufactured and installed into a vehicle.

Referring now to FIG. 6 another point of securement of the door member to the inner layer is illustrated. Here a portion of the door member that deploys from inner layer 16 is illustrated. Here a separable mounting portion 100 of the door member is secured to the inner layer. Mounting portion 100 comprises a standing rib portion 102 and a separable relief portion 104 each of which are located along a periphery of the door member (except for the area comprising the hinge portion e.g., flange portion 82) such that once the airbag module is deployed mounting portion 100 will remain secured to the inner layer while door member 56 separates and pivots along hinge trough 96. In accordance with an exemplary embodiment, relief portion 104 comprises a thinned out area or reduced thickness of material releasably securing a portion of door member 56 to the separable flange or mounting portion 100 such that relief portion 104 is easily torn during airbag deployment and door member 56 will pivot outwardly from the instrument panel.

When the airbag module deploys and door member 56 separates from mounting portion 100 (e.g., tearing of relief portion 104) the foam or intermediary layer 16 will separate or tear along rib portion 102 and on towards the score line 36 on the inside of the outer layer 14, which will also tear or separate along scores 36. Accordingly, rib portion 102 limits the thickness of the foam material disposed between the peak of rib 102 and score 36 in order to facilitate the tearing of the foam portion or intermediate layer during airbag deployment. In other words, rib portion 102 will define a “V” shaped groove in the foam material of the intermediate layer, which facilitates separation of the same. Thus, as door member 56 separates along separable portion 104 intermediate layer 16 and outer layer 14 tear or separate proximate to rib portion 102 and score 36 while a portion or hinge portion of the door member remains secured to the inner layer via flange portion 82, which is secured thereto by bracket 50. In addition, reinforcement areas 94 will also provide increased strength at localized areas corresponding to the securement points comprising weld spuds 70. In addition, wall portion or portions 64 is/are disposed proximate to trough 96 and rib portion 102 in order to provide localized areas of support as the door member separates from the separable flange portion along separable portion 104 while pivoting along trough 96.

Similar to FIG. 5, the mounting bracket of the airbag module housing is configured to have a shorter length and mounting portion 100 will comprise a shoulder portion 106. Shoulder portion 106 will also provide a location feature for securement of door member 56 to the inner layer. Also, inner layer 18 is secured to mounting portion 100 via a plurality of rivets 98, which pass through complimentary openings in the inner layer, mounting portion 100 and mounting or halo bracket 50.

Accordingly, exemplary embodiments of the present invention are directed to a method and apparatus for securing a door member to an inner layer of the instrument panel wherein the securement apparatus also provides a means for securing an airbag module housing to the instrument panel via a plurality of mounting studs disposed about the periphery of a opening in the inner layer. This method also provides a quick and efficient means for securing a deployable door to or about an opening in the inner layer as opposed to cutting a door out of the inner layer and then separately providing the required reinforcing means. In accordance with an exemplary embodiment, the door member is mounted over an opening in the inner layer via a plurality of rivets and studs, wherein a reinforced flange or hinge portion is secured to one portion of the opening and a separable portion is secured about the remaining portions of the opening. In addition, exemplary embodiments of the present invention provide a means for providing an instrument panel with an invisible deployment opening. More specifically, the door member is secured to the inner layer prior to the application of the intermediate layer and the outer layer with a score located on an inner surface. Thus, the door is secured to the inner layer and then the intermediate layer and outer layer are applied resulting in an instrument panel with an exterior show surface wherein the periphery of the deployment opening is not visually perceivable.

In accordance with an exemplary embodiment, door member 56 is formed from a thermoplastic material wherein the features of door member are integrally formed therein. For example, each of the features of the separable flange portion 100 (e.g., shoulder 106, rib 102, thinned area 104 and any required mounting openings for rivets 98 as well as weld spuds 70) and mounting flange 82 (e.g., shoulder 92, reinforcement areas 94 and trough 96 and any required mounting openings for rivets 98 as well as weld spuds 70) are integrally formed therein. One non-limiting means for achieving this would be to provide complimentary tooling for use in an injection molding process to form door member 56 with mounting flange 82 and separable flange portions 100.

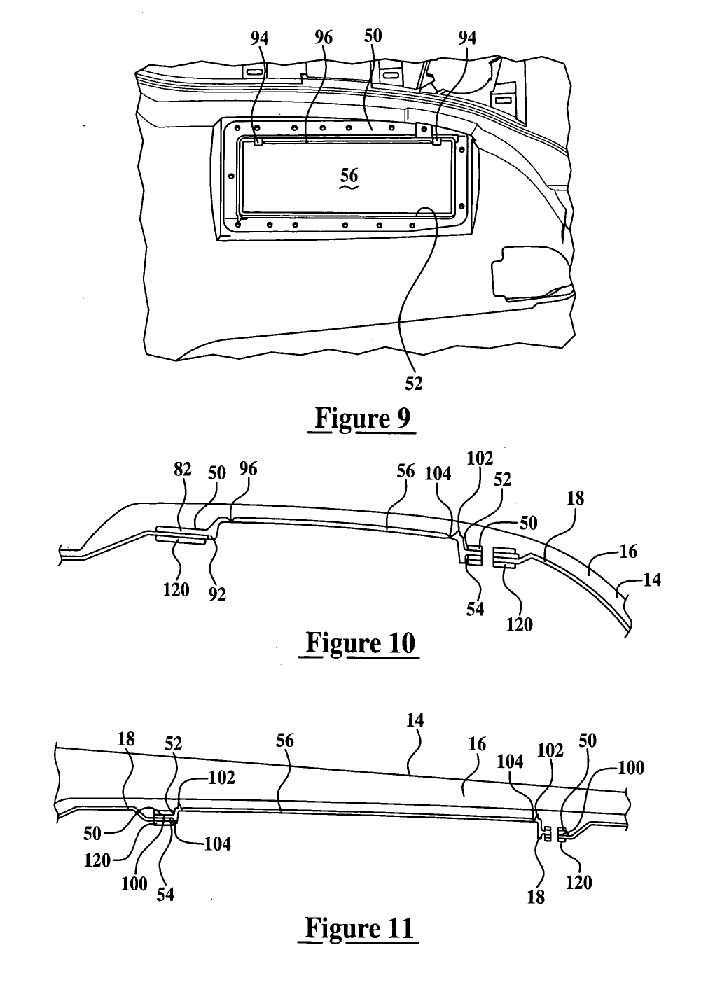

Referring now to FIGS. 7-11, an instrument panel constructed in accordance with an exemplary embodiment of the present invention is illustrated. FIG. 7 illustrates the exterior surface of outer layer 14 while FIG. 8 illustrates an upper surface of inner layer or substrate layer 18. FIG. 9 is an enlarged portion of the airbag deployment area wherein halo bracket or mounting bracket 50 is secured about a periphery of opening 54 in inner layer 18. As previously discussed, mounting bracket 50 provides a means for securing deployment door 56 over opening 54 wherein a flange portion 82 is secured between the halo bracket and the inner layer and wherein removable flange portion 100 is also secured between the halo bracket and the peripheral portion of inner layer 18 defining opening 54. As illustrated, flange portion 82 is secured along the edge of opening 54 closest to the windshield of a vehicle (not shown) while removable flange portion 100 is secured about the remaining periphery of opening 54. It is, of course, understood that flange portion 82 and flange portion 100 can be secured to other portions of opening 54.

Of course, other deployable door configurations are contemplated to be within the scope of exemplary embodiments of the present invention. In addition, more than one door member is also contemplated. For example, non-limiting patterns or configurations include “I” shaped openings, “T” shaped openings or “H” shaped openings.

As illustrated in FIG. 9, hinge trough 96 traverses along an upper edge of door member 56 and is bounded at either end with reinforcing block areas 94. In addition, and as illustrated in FIGS. 6 and 9 rib portion 102 and separable relief portion 104 traverse along the periphery of opening 52 from either end of block portions 94 in order to provide a means for separating door member 56 from separable flange portion 100. Of course, it is understood, that rib portion 102 and separable relief portion 104 may have other configurations than those illustrated in FIG. 9 (e.g., interrupted patterns or non continuous patterns or only being disclosed along one of the door member edges).

As illustrated, halo bracket or mounting bracket 50 is configured to match a peripheral portion or recessed area of inner layer 18. In addition, and as applications may require, mounting bracket 50 will be configured to have a plurality of mounting rivets 98 for securing the door member to the inner layer and a plurality of threaded weld spuds each having a threaded portion for securing a mounting flange of an airbag housing to the inner layer.

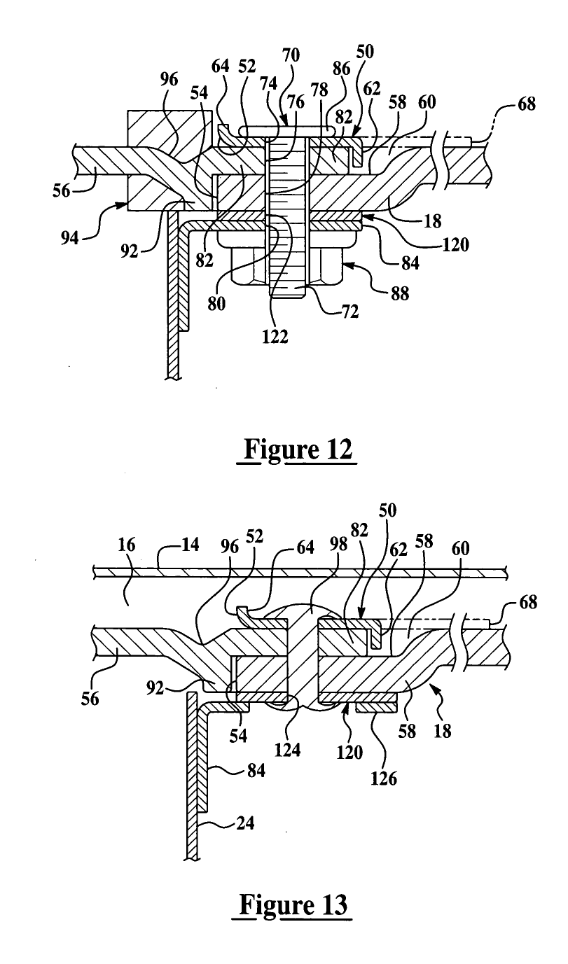

Referring now to FIGS. 12-14, an alternative exemplary embodiment of the present invention is illustrated wherein similar views to FIGS. 4-6 are provided. In this embodiment, a second bracket or second halo bracket 120 is located on the inner surface of inner layer 18, while bracket 50 secures the door member to the upper surface of inner layer 18. Inner bracket 120 is also shown in FIG. 10, it being understood that the instrument panel of exemplary embodiments of the present invention may be constructed with or without bracket 120.

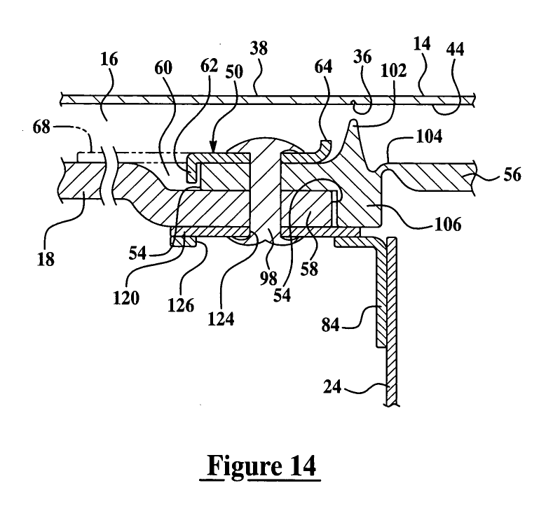

As illustrated in FIG. 12, the second bracket 120 is located between the inner surface of inner layer 18 and the flange portion or mounting bracket 84 of the airbag module housing wherein shaft portion 72 of the weld spud passes through an opening 122 in bracket 120. Referring now to FIGS. 13 and 14, securement of the second bracket to the inner layer is also facilitated by machine rivet 98, which passes through complimentary openings 124 in the second mounting bracket. In this embodiment, the orientation of the rivets is reversed (e.g., the head portion being disposed on top of the first bracket). During this manufacturing process step, the door member is secured to the inner layer covering opening 54 wherein rigid securement of the two items is facilitated. In accordance with an exemplary embodiment, the rivets, the door member and the upper and lower mounting brackets are secured to the inner layer during a manufacturing process step, which occurs prior to the placement of the outer layer and inner layer into a mold wherein layer 16 is inserted therein. Thus, door member 56 is deployably secured to the inner layer via mounting bracket 50 and 120 and a plurality of rivets and studs, wherein the studs are used to secure a portion of an airbag module to the instrument panel.

Also and in this embodiment, the mounting bracket of the airbag module will have an aperture 126. Aperture 126 is configured and positioned to allow deformed second rivet head to pass therethrough while the second bracket is mounted directly to bracket 84. In this embodiment and in comparison to FIGS. 5 and 6, bracket 84 is configured to extend farther away from the periphery of the airbag housing opening located proximate to the areas in which rivets 98 are secured to the upper and lower halo brackets.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. An instrument panel having a hidden airbag module door opening, the instrument panel comprising:
an outer layer having a show surface and an inner surface;
an inner layer having a deployment opening disposed therein;
an intermediary layer disposed between the outer layer and the inner layer; and
a door member secured about the deployment opening via a mounting bracket, wherein a flange portion comprising a hinge is secured between a peripheral edge portion of the deployment opening and the mounting bracket and a separable flange portion of the door member is secured between another peripheral edge portion of the deployment opening and the mounting bracket, wherein the separable flange portion removably secures a portion of the door member to the inner layer, wherein the door member and the bracket are secured to the inner layer prior to the application of the intermediary layer and the intermediary layer covers the door member and the bracket and wherein the periphery of the door member is not visually perceivable from the outer layer.

2. The instrument panel as in claim 1, wherein the hinge is a trough formed in a surface of the door member, wherein the trough does not completely extend through the door member.

3. The instrument panel as in claim 2, wherein the trough is bounded by reinforcing areas aligned with a complimentary mounting stud, the mounting stud being configured to secure the flange portion to the inner member, the reinforcing areas being integrally formed with the door member and depend away from opposite sides of the door member.

4. The instrument panel as in claim 3, wherein the separable flange portion is releaseably secured to the door member via a relief portion defined by a thinned area of material releaseably connecting the separable flange portion to the door member, the thinned area having a thickness less than a thickness of the separable flange portion and a thickness of the door member.

5. The instrument panel as in claim 4, wherein the separable flange portion further comprises an integrally formed rib portion located adjacent to the relief portion, wherein the rib portion depends away from the separable flange portion and is positioned to limit a thickness of the intermediary layer disposed between the outer layer and the separable flange portion and the rib portion is substantially aligned with a score disposed in the inner surface of the outer layer.

6. The instrument panel as in claim 5, wherein the mounting bracket further comprises a wall member configured to be disposed proximate to the rib portion of the separable flange portion or the trough of the flange portion.

7. The instrument panel as in claim 6, wherein the peripheral edge portion of the deployment opening of the inner layer defines a recessed area of the inner layer so that a surface of the door member and a surface of the inner layer are substantially the same distance from the outer layer and the mounting bracket defines an opening slightly larger than the deployment opening in the inner layer and wherein the instrument panel further comprises a second mounting bracket disposed about the deployment opening in the inner layer, the second mounting bracket being secured to the inner layer on a side opposite to the mounting bracket.

8. The instrument panel as in claim 1, wherein inner layer is formed from a thermoplastic material and the intermediary layer is formed of a polyurethane foam and the outer layer is formed of a polyurethane material.

9. The instrument panel as in claim 1, wherein the peripheral edge portion of the deployment opening of the inner layer defines a recessed area of the inner layer so that a surface of the door member and a surface of the inner layer are substantially the same distance from the outer layer and the mounting bracket defines an opening slightly larger than the deployment opening in the inner layer and wherein the instrument panel further comprises a second mounting bracket disposed about the deployment opening in the inner layer, the second mounting bracket being secured to the inner layer on a side opposite to the mounting bracket.

10. The instrument panel as in claim 9, wherein the mounting bracket further comprises a wall member configured to engage an edge of the separable flange portion or the flange portion of the door member and the mounting bracket further comprises an extension portion that extends outwardly from the deployment opening past the wall portion and over the recessed area of the inner layer.

11. The instrument panel as in claim 10, wherein the hinge is a trough formed in a surface of the door member, wherein the trough does not completely extend through the door member and the trough is bounded by reinforcing areas aligned with a complimentary mounting stud, the mounting stud being configured to secure the flange portion to the inner member, the reinforcing areas being integrally formed with the door member and depend away from opposite sides of the door member.

12. The instrument panel as in claim 1, wherein the flange portion further comprises a shoulder portion for locating the door member within the deployment opening.

13. The instrument panel as in claim 1, wherein the separable flange portion further comprises a shoulder portion for locating the door member within the deployment opening.

14. The instrument panel as in claim 1, wherein the mounting bracket further comprises a wall member configured to engage an edge of the separable flange portion or the flange portion of the door member and the inner surface of the outer layer is configured to have at least one score to facilitate tearing of the outer layer.

15. The instrument panel as in claim 1, wherein the hinge is a trough formed in a surface of the door member and the trough does not completely extend through the door member and wherein the separable flange portion is releaseably secured to the door member via a relief portion defined by a thinned area of material releaseably connecting the separable flange portion to the door member, the thinned area having a thickness less than a thickness of the separable flange portion and a thickness of the door member, wherein the mounting bracket is secured to the inner layer via a plurality of rivets and a plurality of air bag mounting studs, the plurality of air bag mounting studs each comprise a threaded portion that depends away from a surface of the inner layer.

16. The instrument panel as in claim 15, wherein the separable flange portion further comprises an integrally formed rib portion located adjacent to the relief portion, wherein the rib portion depends away from the separable flange portion and is positioned to limit a thickness of the intermediary layer disposed between the outer layer and the separable flange portion and the rib portion is substantially aligned with a score disposed in the inner surface of the outer layer, wherein the peripheral edge portion of the deployment opening of the inner layer defines a recessed area of the inner layer so that a surface of the door member and a surface of the inner layer are substantially the same distance from the outer layer and the mounting bracket defines an opening slightly larger than the deployment opening in the inner layer and wherein the instrument panel further comprises a second mounting bracket disposed about the deployment opening in the inner layer, the second mounting bracket being secured to the inner layer on a side opposite to the mounting bracket.

17. An instrument panel and airbag module assembly, comprising:
an outer layer having a show surface and an inner surface, the outer layer having at least one score disposed in the inner surface, wherein the at least one score is not visually perceivable from the show surface;
an inner layer having a deployment opening disposed therein;
an intermediary layer disposed between the outer layer and the inner layer;
a door member secured about the deployment opening via a mounting bracket, wherein a flange portion comprising a hinge is secured between an upper peripheral edge portion of the deployment opening and the mounting bracket and a separable flange portion of the door member is secured between another upper peripheral edge portion of the deployment opening and the mounting bracket, wherein the separable flange portion removably secures a portion of the door member to the inner layer, wherein the door member and the bracket are secured to the inner layer prior to the application of the intermediary layer and the intermediary layer covers the door member and the bracket and wherein the periphery of the door member is not visually perceivable from the outer layer; and
an airbag module housing secured to a lower peripheral edge portion of the deployment opening via a plurality of studs passing through a portion of the mounting bracket, the flange portion and a mounting member of the air bag module housing.

18. The assembly as in claim 17, wherein the hinge is a trough formed in a surface of the door member, wherein the trough does not completely extend through the door member and the trough is bounded by reinforcing areas aligned with at least one of the plurality of studs, the reinforcing areas being integrally formed with the door member and depend away from opposite sides of the door member.

19. The assembly as in claim 17, wherein the separable flange portion is releaseably secured to the door member via a relief portion defined by a thinned area of material releaseably connecting the separable flange portion to the door member, the thinned area having a thickness less than a thickness of the separable flange portion and a thickness of the door member and the separable flange portion further comprises an integrally formed rib portion located adjacent to the relief portion, wherein the rib portion depends away from the separable flange portion towards and is configured to limit a thickness of the intermediary layer disposed between the outer layer and the separable flange portion and the rib portion is substantially aligned with the at least one score disposed in the inner surface of the outer layer, wherein the peripheral edge portion of the deployment opening of the inner layer defines a recessed area of the inner layer so that a surface of the door member and a surface of the inner layer are substantially the same distance from the outer layer and the mounting bracket defines an opening slightly larger than the deployment opening in the inner layer and wherein the instrument panel further comprises a second mounting bracket disposed about the deployment opening in the inner layer, the second mounting bracket being secured to the inner layer between the mounting member of the airbag module housing and the inner layer.

20. The assembly as in claim 17, wherein the peripheral portion of the deployment opening of the inner layer defines a recessed area of the inner layer so that a surface of the door member and a surface of the inner layer are substantially the same distance from the outer layer and the mounting bracket further comprises a wall member configured to engage an edge of the separable flange portion or the flange portion of the door member and the mounting bracket further comprises an extension portion that extends outwardly from the deployment opening past the wall portion and over the recessed area of the inner layer.

21. The assembly as in claim 17, wherein the mounting bracket further comprises a wall member configured to engage an edge of the separable flange portion or the flange portion of the door member and wherein the hinge is a trough formed in a surface of the door member and the trough does not completely extend through the door member and the separable flange portion is releaseably secured to the door member via a relief portion defined by a thinned area of material releaseably connecting the separable flange portion to the door member, the thinned area having a thickness less than a thickness of the separable flange portion and a thickness of the door member and wherein the mounting bracket is secured to the inner layer via a plurality of rivets.

22. A method of forming a hidden, integral passenger airbag door in an instrument panel, the method comprising:
securing a flange portion and a releasable flange portion of a door member to an upper surface of a peripheral edge of a deployment opening in an inner layer of the instrument panel with a mounting bracket, the mounting bracket having a plurality of rivets securing the releasable flange portion and the flange portion between the peripheral edge of the of the deployment opening and the mounting bracket and a plurality of studs securing the releasable flange portion and the flange portion between the peripheral edge of the of the deployment opening and the mounting bracket, wherein a portion of the plurality of studs is configured to secure a portion of an airbag module to the instrument panel;
securing an outer layer and an intermediary layer to the inner layer, the outer layer having a show surface and an inner surface, the outer layer having at least one score disposed in the inner surface, wherein the at least one score is not visually perceivable from the show surface and the intermediary is layer disposed between the outer layer and the inner layer; and
wherein the flange portion further comprises a hinge defined by a trough disposed in a surface of the door member and the trough is bounded by reinforcement areas aligned with at least one of the plurality of studs, the reinforcement areas being integrally formed with the door member and depend away from opposite sides of the door member.

23. The method as in claim 22, further comprising:
securing a second mounting bracket to the inner layer, wherein the flange portion, the releasable flange portion, and a portion of the inner layer are secured between the mounting bracket and the second mounting bracket and, wherein the separable flange portion is releaseably secured to the door member via a relief portion defined by a thinned area of material releaseably connecting the separable flange portion to the door member, the thinned area having a thickness less than a thickness of the separable flange portion and a thickness of the door member and the separable flange portion further comprises an integrally formed rib portion located adjacent to the relief portion, wherein the rib portion depends away from the separable flange portion and is positioned to limit a thickness of the intermediary layer disposed between the outer layer and the separable flange portion and the rib portion is substantially aligned with the at least one score disposed in the inner surface of the outer layer, wherein the peripheral edge portion of the deployment opening of the inner layer defines a recessed area of the inner layer and the mounting bracket defines an opening slightly larger than the deployment opening in the inner layer.
